(19) United States
(12) Patent Application Publication
(10) Pub. No.: US 2012/0191955 A1
(43) Pub. Date: Jul. 26, 2012

(54) METHOD AND SYSTEM FOR FLOATING POINT ACCELERATION ON FIXED POINT DIGITAL SIGNAL PROCESSORS

(76) Inventors: Ragnar H. Jonsson, Laguna Niguel, CA (US); Sveinn V. Grimsson, Newport Beach, CA (US); Vilhjalmur Thorvaldsson, Irvine, CA (US); Trausti Thormundsson, Irvine, CA (US)

(21) Appl. No.: 13/010,586

(22) Filed: Jan. 20, 2011

(51) Int. Cl. G06F 9/302

(52) U.S. Cl. 712/222; 712/E09.017

(57) ABSTRACT

A system for performing floating point operations comprising a floating point multiply function that utilizes one or more fixed point functional blocks of a processor and one or more dedicated floating point functional blocks of the processor. A floating point add function that utilizes one or more fixed point functional blocks of a processor and one or more dedicated floating point functional blocks of the processor. A floating point normalize function that utilizes one or more fixed point functional blocks of a processor and one or more dedicated floating point functional blocks of the processor.

### FIELD OF THE INVENTION

The invention relates to data processing, and more particularly to a method and system for floating point acceleration on fixed point digital signal processors.

### BACKGROUND OF THE INVENTION

Most digital signal processors (DSP) only support fixed point operations, because of the excessive cost for hardware to support floating point operations. As a result, fixed point processors do not have an efficient support mechanism for performing floating point operations, and any code that requires floating point operations runs significantly slower on the fixed point processors.

Previous solutions include providing full floating point support with the associated increase in hardware size, or to implement floating point operations in software with an associated degradation in performance. As a result, the most common solution is not to do floating point operations on fixed point processors, but to convert floating point code to fixed point code, which can require significant development time and which can also result in performance degradation.

### SUMMARY OF THE INVENTION

By providing special instructions to speed up floating point operations without providing full floating point support, it s possible to provide efficient floating point support without too much increase in the additional amount of hardware.

### BRIEF DESCRIPTION OF THE SEVERAL VIEWS OF THE DRAWINGS

FIG. 1 is a diagram of a system for implementing the fmul instruction in accordance with an exemplary embodiment of the present disclosure;

FIG. 2 is a diagram of a system for implementing the fadd instruction in accordance with an exemplary embodiment of the present invention; and

FIG. 3 is a diagram of a system for implementing the fnorm instruction in accordance with an exemplary embodiment of the present invention.

### DETAILED DESCRIPTION OF PREFERRED EMBODIMENTS

In the description that follows, like parts are marked throughout the specification and drawings with the same reference numerals, respectively. The drawing figures might not be to scale and certain components can be shown in generalized or schematic form and identified by commercial designations in the interest of clarity and conciseness.

In one exemplary embodiment, the present invention allows instructions to be implemented that accelerate floating point operations without significantly increasing the hardware size. In one exemplary embodiment, existing processing blocks of the fixed point processor are used with additional floating point processing blocks, to allow floating point operations to be performed more efficiently than would be possible if floating point operations were performed using software alone.

In another exemplary embodiment, a plurality of new instructions can be added that utilize existing processing blocks of the fixed point processor. Instead of using IEEE 754-2008 format numbers, floating point number are represented using 32-bits and 64-bits. The 32-bit representation has a 24-bit significand (also known as a coefficient, fraction or mantissa) and an 8-bit exponent. The significand would be in Q0.23 (Q23) format, instead of the signed magnitude format used in IEEE 754. The 64-bit representation has 56-bit significant and an 8-bit exponent. In one exemplary embodiment, the significant can be in Q9.46 format instead of the signed magnitude format used in IEEE 754.

For example, a new instruction “FMUL A, R0, R1” can be added that has the following properties:

A.Q46=R0.Q23*R1.Q23

A.EXP=R0.EXP+R1.EXP

where the value “A” is 64-bit in Q9.46 format and is obtained by multiplying the Q23 significand from register R0 with the Q23 significand from register R1, and the exponent of A is obtained by adding the exponent from register R0 with the exponent from register R1. In this exemplary embodiment, the multiplier functional block can be a fixed point multiplier, and the functional blocks for extracting the significands and exponents, adding the exponents and combining the final significand and exponent can be dedicated functional blocks.

An additional new instruction “FNORM64 R, A” can also be added that has the following properties:

exp=count_leading_sign(A.Q46)

R.Q23=(Q23)(A.Q46<<exp)

R.EXP=A.EXP−exp

where the value of “exp” is equal to the count of the leading sign bits of the Q9.46 value of A, the significand of “R” is the Q23 value of the Q46 value of A shifted by the value of “exp” and converted to Q23 value, and the exponent of “R” is the exponent value of A minus the value of “exp.” In this exemplary embodiment, the count leading sign and shift left functional blocks can be fixed point functional blocks, and the functional blocks for extracting the significands and exponents, subtracting the exponents and combining the final significand and exponent can be dedicated floating point functional blocks.

A third new instruction “FADD1 R3, R0, R1” can also be added that has the following properties:

exp=max(R0.EXP, R1.EXP)

R3.Q23=R0.Q23>>(exp-R0.EXP)

R0.EXP=exp

where the value of the exponent of R3 is the maximum value of the exponent of R0 and R1, and the value of the significand of R3 is the Q23 value of the significand of R0 shifted by the value of “exp” minus the exponent of R0. In this exemplary embodiment, the add and shift right functional blocks can be fixed point functional blocks, and the functional blocks for extracting the significands and exponents, subtracting the exponents, determining the max of exponents and combining the final significand and exponent can be floating point functional blocks.

A fourth new instruction “FADD2 R3, R0, R1” with the following properties

R3.Q23=R0.Q23 +(R1.Q23>>(R0.EXP-R1.EXP))

R3.EXP=R0.EXP

where the value of the exponent of R3 is the value of the exponent of R0, and the value of the significand of R3 is the Q23 value of the significand of R0 added to the Q23 value of the significand of R1 shifted by the value of the exponent of R0 minus the exponent of R1. In this exemplary embodiment, the add and shift right functional blocks can be fixed point functional blocks, and the functional blocks for extracting the significands and exponents, subtracting the exponents, determining the max of exponents and combining the final significand and exponent can be floating point functional blocks.

A fifth new instruction “FNORM32 R1, R0” can be added with the following properties

exp=count_leading_sign(R0.Q23)

R1.Q23 =(R0.Q23<<exp)

R1.EXP=R0.EXP−exp

where the value of “exp” is the count of the leading sign bits of the significand of R0, the significand of R1 is the Q23 value of the significand of R0 shifted by “exp,” and the exponent of R1 equals the exponent of R0 minus “exp.” In this exemplary embodiment, the count leading sign and shift left functional blocks can be fixed point functional blocks, and the functional blocks for extracting the significands and exponents, subtracting the exponents and combining the final significand and exponent can be floating point functional blocks.

Using these new instructions (FMUL, FNORM64, FADD1, FADD2 and FNORM32), a floating point multiplication can be performed as follows:

FMUL a0, r0, r1

FNORM64 r2, a0

A floating point addition can be performed as follows:

FADD1 r2, r0, r1

FADD2 r3, r2, r1

FNORM32 r2, r3

It is also possible to combine the instructions FADD1 and FADD2 into a single instruction “FADD R3, R0, R1” using the following properties:

exp=max(R0.EXP,R1.EXP)

R3.Q23=(R0.Q23>>(exp-R0.EXP))+(R1.Q23>>(exp−R1.EXP))

R3.EXP=exp

In processors with multiple execution stages in the pipeline, it is also possible to combine FADD1 and FADD2 into a single instruction, FADD, by executing the operations of each instruction in separate phases of the pipeline.

Exception handling can be made fairly simple with this scheme. One exception that needs special attention is when the addition in FADD2 generates overflow. In this case, the NORM instructions need to do an unsigned shift down by one bit to correct for the overflow.

This format is one bit less accurate than the IEEE 754 binary32 format. Some dynamic range may need to be sacrificed to simplify exception handling.

It is also possible to do a similar floating point operation based on the IEEE 754-2008 binary32 format, with the following modifications.

The new instruction FMUL A, R0, R1 is changed to:

A.Q46=R0.Q23*R1.Q23

A.EXP=R0.EXP+R1.EXP

A.SIGN=R0.SIGN ̂ R1.SIGN

The new instruction FADD2 R3, R0, R1 is changed to:

tmp=(R0.SIGN̂R1.SIGN)? R0.Q23−(R1.Q23>>(R0.EXP−R1.EXP)):

R0.Q23+(R1.Q23>>(R0.EXP−R1.EXP))

R3.Q23=abs(tmp)

R3.EXP=R0.EXP

R3.SIGN=R0.SIGN ̂ sign(tmp)

The other instructions are the same.

Another exemplary embodiment is to use the first method, except that the addition operator is implemented using an accumulator that is wider than 32-bits. For example if the accumulator is 64-bits wide, then the accumulator can hold the significand in a Q9.46 format and an 8-bit exponent. This configuration provides 9 guard bits, and the addition can be done more than 500 times without danger of overflow.

This configuration also reduces the need for normalization between additions. Without frequent normalization, there is a danger of “underflow” where the significand becomes zero or close to zero, resulting in a loss of accuracy.

Another variation is to use the fixed point multipliers to do the shift for the addition instructions. In this case the R0.Q23 and R1.Q23 are multiplied by (1<<n), such that the multiplication is equivalent to the shift operation. Other operations such as multiply accumulate and floating point subtraction are simple extensions of instructions described above.

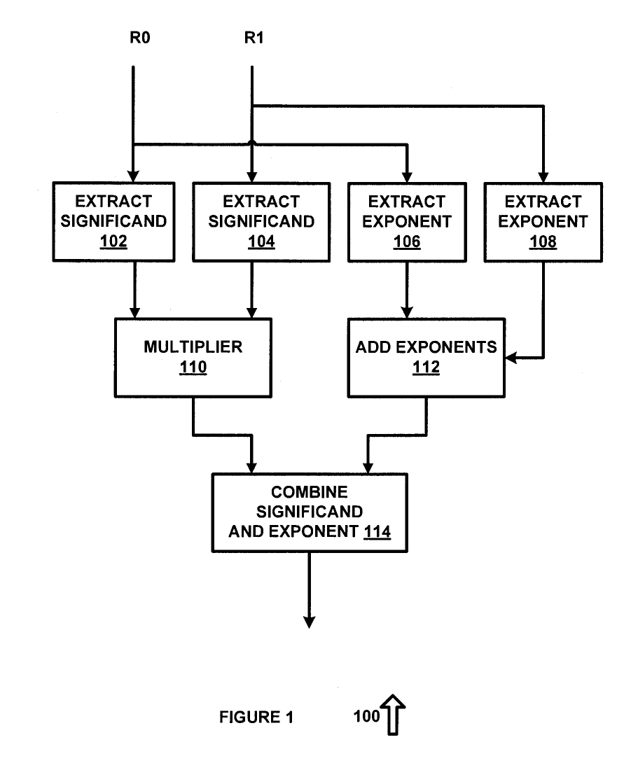

FIG. 1 is a diagram of a system 100 for implementing the fmul instruction in accordance with an exemplary embodiment of the present disclosure. System 100 can be implemented as an instruction in a digital signal processor or in other suitable manners.

System 100 includes extract significand 102 and 104 and extract exponent 106 and 108, which can be implemented as new floating point functional blocks in a digital signal processor, or in other suitable manners. As discussed above, values stored in registers R0 and R1 are received at extract significand 102 and 104 and extract exponent 106 and 108, respectively, and the significand and exponent of each value is extracted. Multiplier 110, which can be an existing fixed point functional block in a digital signal processor, is used to receive and multiply the significand of R0 and R1. Add exponents 112 is used to receive and add the exponents of R0 and R1. Combine significand and exponent 114 can be implemented as a new dedicated floating point functional block in a digital signal processor and is used to receive and add the multiplied significands and the added exponents, to generate the floating point output. Pipelining of functional blocks can also or alternatively be used to reduce the number of functional blocks, such as where a single functional block is used in two consecutive computing clock cycles instead of using two separate and identical functional blocks in a single computing clock cycle.

In operation, system 100 provides an architecture that uses existing fixed point and new dedicated floating point functional blocks of a digital signal processor to implement a floating point multiply function. System 100 thus provides hardware support for floating point multiplication using one or more existing fixed point functional blocks of the digital signal processor or other suitable processor, by adding one or more additional dedicated floating point functional blocks.

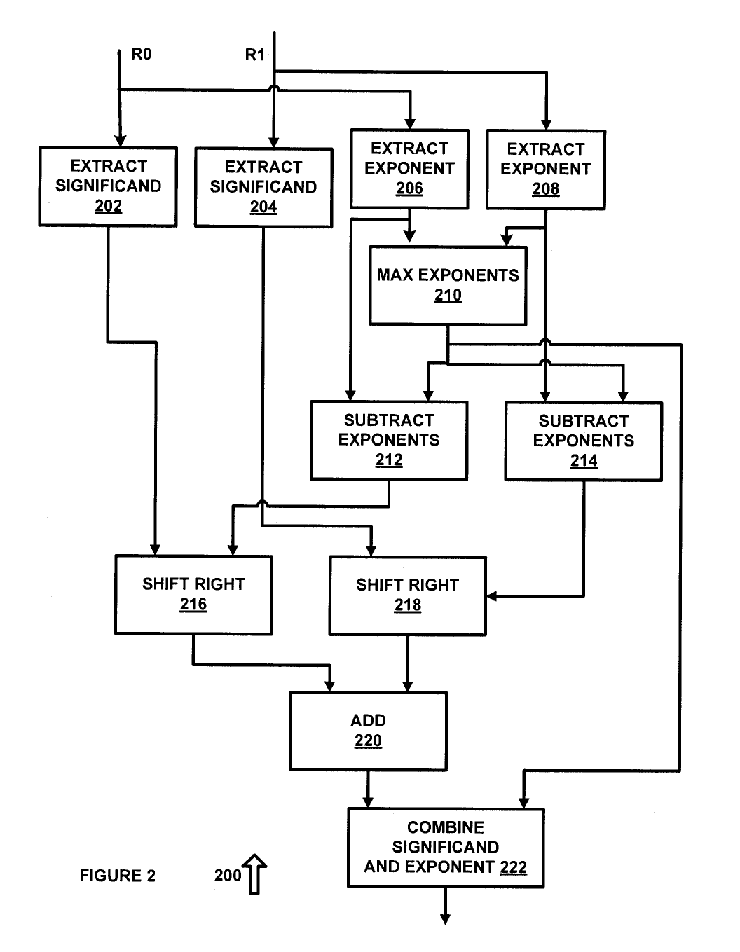

FIG. 2 is a diagram of a system 200 for implementing the fadd instruction in accordance with an exemplary embodiment of the present disclosure. System 200 can be implemented as a new instruction in a digital signal processor or in other suitable manners.

System 200 includes extract significand 202 and 204 and extract exponent 206 and 208, which can be implemented as new floating point functional blocks in a digital signal processor, or in other suitable manners. As discussed above, values stored in registers R0 and R1 are received at extract significand 202 and 204 and extract exponent 206 and 208, respectively, and the significand and exponent of each value is extracted. Max exponents 210 can be implemented as a new dedicated functional block in a digital signal processor and receives and determines the maximum of the two exponent values of R0 and R1. Subtract exponent 212 and 214 can be implemented as new dedicated functional blocks in a digital signal processor that receive the maximum exponent value and the exponent values of R0 and R1, respectively, and subtract that value from the value of the maximum exponent. Shift right 216 and 218 can be implemented as existing fixed point functional blocks of a digital signal processor that receive the significand of R0 and R1 and the output of subtract exponent 212 and 214, respectively, and which shift 1) the significand of R0 by the output of subtract exponent 212, and 2) the significand of R1 by the output of subtract exponent 214, respectively. Add 220 can be implemented as an existing functional block that receives and adds the output of shift right 216 and 218. Combine significand and exponent 222 can be implemented as a new dedicated functional block of a digital signal processor that combines the significand output from add 220 with the exponent output from max exponents 210 to generate the floating point addition value of R0 and R1. Pipelining of functional blocks can also or alternatively be used to reduce the number of functional blocks, such as where a single functional block is used in two consecutive computing clock cycles instead of using two separate and identical functional blocks in a single computing clock cycle.

In operation, system 200 provides an architecture that uses existing and new functional blocks of a digital signal processor to implement a floating point add function. System 200 thus provides hardware support for floating point addition using one or more existing fixed point functional blocks of the digital signal processor or other suitable processor, by adding one or more dedicated floating point functional blocks.

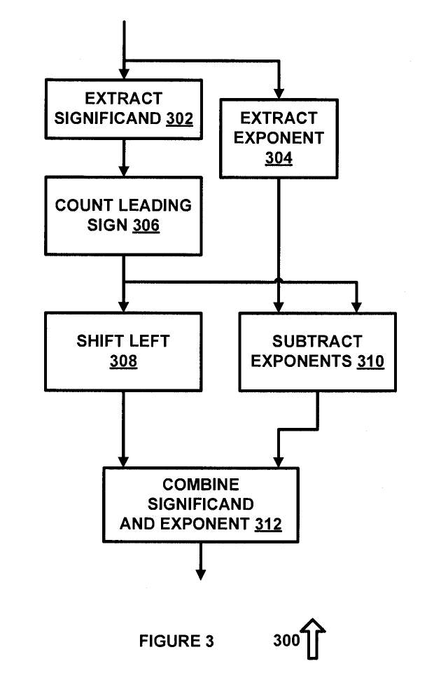

FIG. 3 is a diagram of a system 300 for implementing the fnorm instruction in accordance with an exemplary embodiment of the present disclosure. System 300 can be implemented as a new instruction in a digital signal processor or in other suitable manners.

System 300 includes extract significand 302 and extract exponent 304, which can be implemented as new dedicated floating point functional blocks in a digital signal processor, or in other suitable manners, and which extract the significand and exponent of R0, respectively. Count leading sign 306 can be implemented as an existing fixed point functional block that counts the leading sign bits of the significand of R0. Shift left 308 can be implemented as an existing fixed point functional block of a digital signal processor that generates the Q23 value of the significand of R0 shifted by the output of count leading sign 306. Subtract exponents 310 can be implemented as a new dedicated floating point functional block that subtracts the output of count leading sign 306 from the exponent value of R0. Combine significand and exponent 312 can be implemented as a new floating point functional block of a digital signal processor and can receive the output of shift left 308 and subtract exponents 310 to generate the normalized floating point output.

In operation, system 300 provides an architecture that uses existing and new functional blocks of a digital signal processor to implement a floating point normalization function. System 300 thus provides hardware support for floating point normalization using one or more existing fixed point functional blocks of the digital signal processor or other suitable processor, by adding one or more dedicated floating point functional blocks.

In one exemplary embodiment, these instructions can be used, as shown in the following description, using C code for implementing fixed point and floating point functions.

The fmul, fadd, and fnorm are floating point acceleration instructions with the following behavior, as previously discussed:

### FMUL A, R0, R1:

A.Q46=R0.Q23*R1.Q23

A.EXP=R0.EXP+R1.EXP

### FADD A2, A0, A1:

exp=max(A0.EXP,A1.EXP)

A2.Q46=(A0.Q46>>(exp-A0.EXP))+(A1.Q46>>(exp-A1.EXP))

A2.EXP=exp

### FNORM64 A2, A0:

exp=count_leading_sign(A0.Q46)

A2.Q46=A0.Q46<<exp

A2.EXP=A0.EXP−exp

Where A registers are 64-bit and R registers are 32-bit.

The first example is a simple code that calculates “a*b+q,” to demonstrate the use of floating point multiplication and addition acceleration instructions:

float32_t float_example1(float32_t a, float32_t b, float64_t q){

| | |
|---|---|
| float32_t d; | // special 32-bit floating point format |
| float64_t r; | // special 64-bit floating point format |
| r = a*b; | // ASM: fmul b0,dx1,dy0 |
| r = q + r; | // ASM: fadd a0,a0,b0 |
| d = (float32_t)r; | // ASM: fnorm dx0,a0 |
| return(d); | // ASM: ret.d |
| } | |

In a second example, it is demonstrated how these instructions can be used in FIR filter or vector dot-product:

float64_t float_example2(float32_t *a, float32_t _{——}Y *b) {
int n;
float64_t sum = 0;
for(n=0;n<256;n++)

sum += (*a++) * (*b++);

sum = fnorm(sum);
return(sum);
}

These exemplary embodiments are provided for the purposes of demonstrating certain applications of the disclosed floating point instructions, which can be used to perform other suitable applications.

While certain exemplary embodiments have been described in detail and shown in the accompanying drawings, it is to be understood that such embodiments are merely illustrative of and not restrictive on the broad invention. It will thus be recognized to those skilled in the art that various modifications may be made to the illustrated and other embodiments of the invention described above, without departing from the broad inventive scope thereof. It will be understood, therefore, that the invention is not limited to the particular embodiments or arrangements disclosed, but is rather intended to cover any changes, adaptations or modifications which are within the scope and the spirit of the invention defined by the appended claims.

What is claimed is:

1. A system for performing floating point operations comprising:
a floating point multiply function that utilizes one or more fixed point functional blocks of a processor and one or more dedicated floating point functional blocks of the processor;
a floating point add function that utilizes one or more fixed point functional blocks of a processor and one or more floating point functional blocks of the processor; and
a floating point normalize function that utilizes one or more fixed point functional blocks of a processor and one or more floating point functional blocks of the processor.

2. The system of claim 1 wherein the floating point multiply function utilizes a fixed point multiplier functional block.

3. The system of claim 1 wherein the floating point multiply function utilizes a floating point extract significand functional block.

4. The system of claim 1 wherein the floating point multiply function utilizes a floating point extract exponent functional block.

5. The system of claim 1 wherein the floating point multiply function utilizes a floating point combine significand and exponent functional block.

6. The system of claim 1 wherein the floating point multiply function utilizes a fixed point add exponents functional block.

7. The system of claim 1 wherein the floating point add function utilizes a fixed point shift functional block.

8. The system of claim 1 wherein the floating point add function utilizes a fixed point add functional block.

9. The system of claim 1 wherein the floating point add function utilizes a floating point extract significand functional block.

10. The system of claim 1 wherein the floating point add function utilizes a floating point extract exponent functional block.

11. The system of claim 1 wherein the floating point add function utilizes a floating point max exponents functional block.

12. The system of claim 1 wherein the floating point add function utilizes a floating point subtract exponents functional block.

13. The system of claim 1 wherein the floating point add function utilizes a floating point combine significand and exponent functional block.

14. The system of claim 1 wherein the floating point normalize function utilizes a fixed point shift functional block.

15. The system of claim 1 wherein the floating point normalize function utilizes a fixed point count leading sign functional block.

16. The system of claim 1 wherein the floating point normalize function utilizes a floating point extract significand functional block.

17. The system of claim 1 wherein the floating point normalize function utilizes a floating point extract exponent functional block.

18. The system of claim 1 wherein the floating point normalize function utilizes a floating point subtract exponents functional block.

19. The system of claim 1 wherein the floating point normalize function utilizes a floating point combine significand and exponent functional block.

20. A system for performing floating point operations comprising:
a floating point multiply function that utilizes a fixed point multiplier functional block, a floating point extract significand functional block, a floating point extract exponent functional block, a fixed point add exponents functional block and a floating point combine significand and exponent functional block;
a floating point add function that utilizes a fixed point shift functional block, a fixed point add functional block, a floating point extract significand functional block, a floating point extract exponent functional block, a floating point max exponents functional block, a floating point subtract exponents functional block and a floating point combine significand and exponent functional block; and
a floating point normalize function that utilizes a fixed point shift functional block, a fixed point count leading sign functional block, a floating point extract significand functional block, a floating point extract exponent functional block, a floating point subtract exponents functional block and a floating point combine significand and exponent functional block.
